(19) United States
(12) Patent Application Publication
(10) Pub. No.: US 2021/0152953 A1
(43) Pub. Date: May 20, 2021

(54) BATTERY PACK, WIRELESS POWER TRANSMISSION SYSTEM, AND HEARING AID

(71) Applicant: NITTO DENKO CORPORATION, Ibaraki-shi, Osaka (JP)

(72) Inventors: Taiki SUEYOSHI, Osaka (JP); Masami INOUE, Osaka (JP); Hisashi TSUDA, Osaka (JP); Toru MIZUTANI, Osaka (JP); Kaoru ITO, Osaka (JP); Daigo TSUBAI, Osaka (JP); Hideshi YAMAKAWA, Osaka (JP)

(73) Assignee: NITTO DENKO CORPORATION, Ibaraki-shi, Osaka (JP)

(21) Appl. No.: 16/620,560

(22) PCT Filed: Jul. 31, 2018
(86) PCT No.: PCT/JP2018/028579

§ 371 Date: Dec. 9, 2019

(30) Foreign Application Priority Data
Jul. 31, 2017 (JP) 2017-148351

(51) Int. Cl. H04R 25/00; H02J 50/10; H01M 50/204; H01M 10/46; H02J 50/00

(52) U.S. Cl. CPC H04R 25/602; H04R 25/609; H02J 50/005; H01M 50/204; H01M 10/46; H02J 50/10

(57) ABSTRACT

A battery pack includes a secondary battery, a coil member, a circuit board, a housing, and a metal member. The metal member has a plurality of strip portions extending along the direction orthogonal to the thickness direction of the housing from the inside of the housing toward the peripheral end edge, and connected to each other inside the housing. The plurality of strip portions each has an end edge positioned at the peripheral end edge of the housing, and each of the end edges of the plurality of strip portions is position defined at different positions at the peripheral end edge of the housing.

### TECHNICAL FIELD

The present invention relates to a battery pack, and a wireless power transmission system and a hearing aid including the battery pack.

### BACKGROUND ART

Conventionally, a wirelessly chargeable secondary battery unit has been known. Such a secondary battery unit can be wirelessly charged using a matching charger while the unit is attached to the electronic device, and therefore it is highly convenient.

Patent Document 1 discloses, for example, such a secondary battery unit. The battery unit described in Patent Document 1 includes a secondary battery; a power-receiving coil that receives power supplied from outside; a circuit board that charges the secondary battery using the power received; a case accommodating the secondary battery, power-receiving coil, and circuit board; a positive electrode output terminal provided at a position corresponding to the positive electrode of the secondary battery; and a negative electrode output terminal provided at a position corresponding to the negative electrode of the secondary battery.

### CITATION LIST

### Patent Document

### Patent Document 1: Japanese Unexamined Patent Publication No. 2015-88376

### SUMMARY OF THE INVENTION

### Problem to be Solved by the Invention

Meanwhile, with the battery unit described in Patent Document 1, the positive electrode output terminal is disposed at the same plane with the power-receiving coil, and therefore the disposition of the positive electrode output terminal is limited by the power-receiving coil. To be specific, the positive electrode output terminal is disposed near the peripheral edge portion dislocated from the center of the case. Therefore, when the battery unit is tried to be attached to the electronic device, it may be difficult to allow the terminal of the electronic device to contact the positive electrode output terminal. That is, there are disadvantages in that it is difficult to attach the battery unit to the electronic device.

Furthermore, when the design is made to dispose the positive electrode output terminal at a center side in the surface direction of the battery unit to easily attach the battery unit to the electronic device, the positive electrode output terminal has to be disposed so that it is over one side of the power-receiving coil in the thickness direction (in FIG. 1 of Patent Document 1, upper face). Then, because the positive electrode output terminal is a thin plate member extending from the circuit board, the positive electrode output terminal may be deformed by pressure or impact from the terminal of the electronic device. As a result, there are disadvantages in that contact failure between the positive electrode output terminal and the terminal of the electronic device may be caused.

The present invention provides a battery pack that can be easily attached to the terminal of the electronic device, and that has excellent connection reliability with the terminal of the electronic device; a wireless power transmission system; and a hearing aid.

### Means for Solving the Problem

The present invention [1] includes a battery pack including a secondary battery having a battery negative electrode terminal disposed at one side in the thickness direction and a battery positive electrode terminal disposed at the other side in the thickness direction; a coil member, a circuit board electrically connected with the battery negative electrode terminal, the battery positive electrode terminal, and the coil member, a housing that accommodates the secondary battery, the coil member, and the circuit board; and a metal member disposed at the other side in the thickness direction relative to the housing and is electrically connected to the circuit board; wherein the metal member has a plurality of strip portions extending along the direction orthogonal to the thickness direction of the housing from the inside of the housing toward the peripheral end edge, and connected to each other inside the housing, the plurality of strip portions each has an end edge positioned at the peripheral end edge of the housing, and each of the end edges of the plurality of strip portions is position defined at different positions at the peripheral end edge of the housing.

With this battery pack, the metal member is disposed at the other side in the thickness direction of the housing, and is electrically connected with the circuit board, and therefore it functions as a terminal. Furthermore, because the metal member (terminal) is disposed at the other side in the thickness direction of the housing, the position is not limited by the coil member disposed inside the housing. That is, there is no need to design the terminal to be provided in the surface direction avoiding the coil member. Thus, the metal member (terminal) can be disposed at a position where the terminal of the electronic device can be easily contacted. As a result, the battery pack can easily be attached to the electronic device.

Also, the metal member has the plurality of strip portions, and furthermore, the end edge of the strip portions is position defined at the peripheral end edge of the housing. Therefore, the metal member, i.e., the terminal, is stably fixed to the housing at multiple points, and therefore the metal member is not easily deformed by pressure and impact from the terminal of the electronic device while making contact with the terminal of the electronic device. Thus, connection reliability with the electronic device is excellent.

The present invention [2] includes the battery pack described in [1], wherein the metal member is electrically connected with the circuit board at the end edge of the strip portion.

With this battery pack, the lining of wires for electrically connecting the circuit board with the metal member is unnecessary between the coil member and the metal member. Therefore, effects on the magnetic field (magnetic field at the time of power supply) between the power-supplying coil of the power-supplying device and the coil member of the battery pack from the electric current flowing in the wire between the circuit board and the metal member or magnetic field generating therefrom can be suppressed. Therefore, decline in power supply efficiency can be suppressed.

The present invention [3] includes the battery pack described in [1] or [2], wherein the metal member has at least three strip portions.

With this battery pack, the metal member can be positioned with respect to the housing with the end edges of the three or more strip portions. Thus, the metal member allows for more stable fixing to the housing, and improvement in connection reliability even more.

The present invention [4] includes the battery pack described in any one of [1] to [3], including a center portion overlapping with a center of the secondary battery when projected in the thickness direction, wherein the strip portion extends radially from the center portion.

With this battery pack, the metal member includes the center portion, and therefore the terminal of the electronic device can easily contact the metal member. Therefore, connection reliability can be improved even more.

The present invention [5] includes the battery pack described in any one of [1] to [4], wherein the end edge of the strip portion has a fitting portion, and the peripheral end edge of the housing has a fitted portion to which the fitting portion fits.

With this battery pack, the metal member fits the peripheral end edge of the housing, and the metal member can be fixed to the housing more strongly.

The present invention [6] includes the battery pack described in any one of [1] to [5], wherein the end edge of the strip portion has a hook extending inward from the distal end of the fitting portion.

With this battery pack, the metal member has the hook at the end edge, and therefore the hook of the metal member can press the housing and the secondary battery accommodated in the housing to the opposite side of the metal member. Thus, the metal member can suppress generation of gaps between the housing and the secondary battery, and wobbling of the secondary battery in the housing. Also, the metal member can be suppressed from falling from the battery pack.

The present invention [7] includes the battery pack described in any one of [1] to [6], wherein the secondary battery includes a positive electrode tab and a negative electrode tab.

With this battery pack, the circuit board and the secondary battery can be electrically connected through the positive electrode tab, and therefore electrical connection between the circuit board and the secondary battery can be improved even more. Also, the circuit board and the secondary battery can be electrically connected through the negative electrode tab, and therefore electrical connection between the circuit board and the secondary battery can be improved even more. Furthermore, because the up-down direction position of the negative electrode side of the secondary battery can be adjusted by the negative electrode tab, the terminal of the electronic device can be smoothly lead to the battery negative electrode terminal, and the battery pack can be easily attached to the electronic device.

The present invention [8] includes a wireless power transmission system including the battery pack described in any one of [1] to [7], and a power-supplying device including a power-supplying coil.

With the wireless power transmission system, by driving the power-supplying device, electric power can be transmitted wirelessly to the secondary battery of the battery pack, and therefore the secondary battery can be wirelessly charged.

The present invention [9] includes a hearing aid including the battery pack described in any one of [1] to [7], a hearing aid housing having an accommodation unit that accommodates the battery pack, and a microphone, amplifier, and speaker provided inside the hearing aid housing.

With this hearing aid, the battery pack can be easily attached, and connection reliability with the battery pack is excellent.

### Effects of the Invention

The battery pack and wireless power transmission system of the present invention are easily attached to the terminal of the electronic device such as hearing aids, and connection reliability with the terminal of the electronic device is excellent. The hearing aid of the present invention is easily attached to the battery pack, and connection reliability with battery pack is excellent.

### BRIEF DESCRIPTION OF THE DRAWINGS

FIGS. 1A-B are perspective views of the battery pack in an embodiment of the present invention, FIG. 1A showing a perspective view seeing from the upper side, and FIG. 1B showing a perspective view seeing from the lower side.

FIGS. 2A-B are perspective views of the secondary battery used for the battery pack shown in FIG. 1A, FIG. 2A showing a perspective view seeing from the upper side, and FIG. 2B showing the perspective view seeing from the lower side.

FIGS. 3A-B are developed views of a coil-included board used for the battery pack shown in FIG. 1A, FIG. 3A showing a plan view and FIG. 3B showing a bottom view.

FIG. 4 shows a cross sectional view of the coil-included board shown in FIG. 3A, showing A-A side.

FIG. 5 shows an exploded perspective view of the battery pack shown in FIG. 1A.

FIGS. 6A-B show the battery pack shown in FIG. 1A, FIG. 6A showing a plan view and FIG. 6B showing a bottom view.

FIGS. 7A-B show the battery pack shown in FIG. 6A, FIG. 7A showing the A-A side cross sectional view and FIG. 7B showing the B-B side cross sectional view.

FIG. 8 shows a block diagram of the wireless power transmission system in an embodiment of the present invention.

FIG. 9 shows exploded perspective views of the hearing aid in an embodiment of the present invention, FIG. 9A showing an opened state and FIG. 9B showing a closed state.

FIG. 10 shows a side cross sectional view (corresponding to A-A side cross sectional view of FIG. 7A) of the battery pack in a modified example of the present invention.

FIG. 11 shows a metal member used for the battery pack shown in FIG. 10.

### DESCRIPTION OF THE EMBODIMENTS

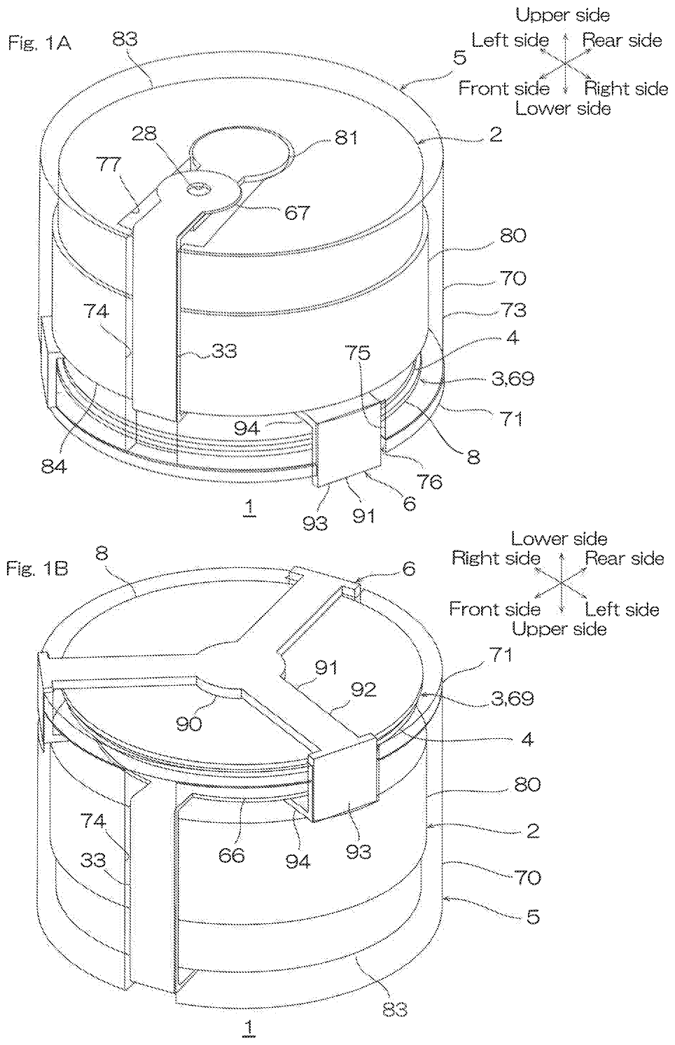

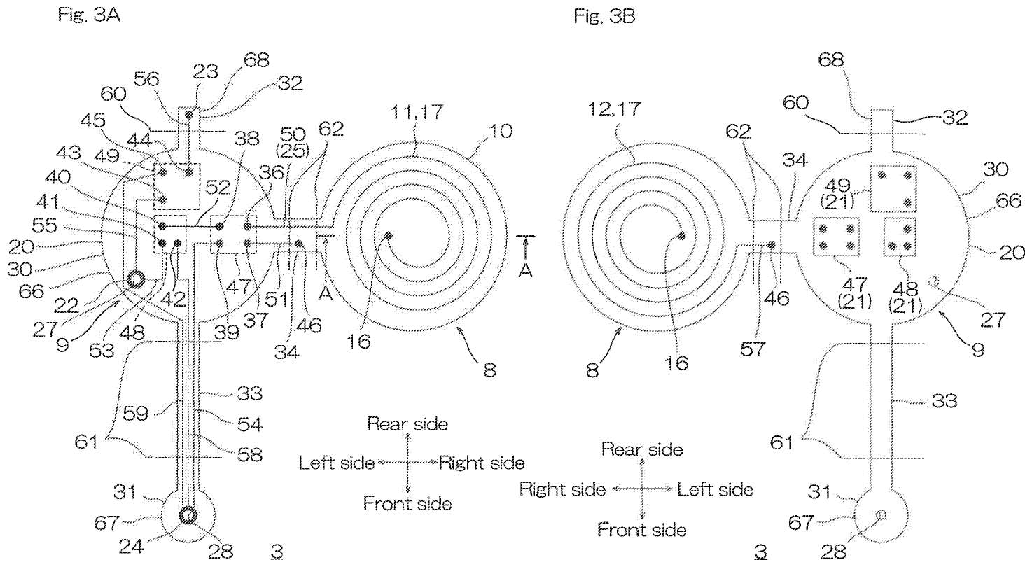

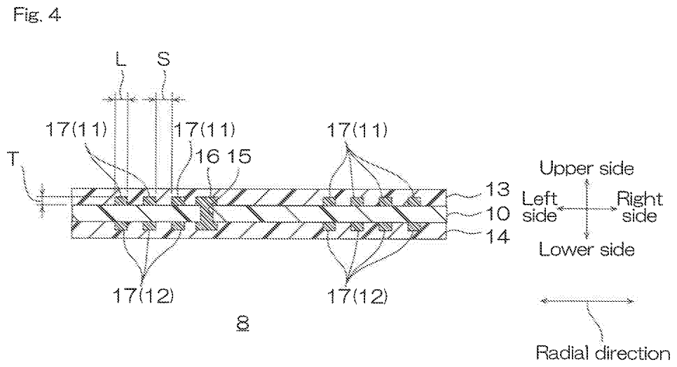

An embodiment of the present invention is described below with reference to drawings. In FIG. 4, up-down direction on paper surface is up-down direction (thickness direction, first direction), upper side on paper surface is upper side (one side in thickness direction, one side in first direction), lower side on paper surface is lower side (the other side in thickness direction, the other side in first direction). In FIG. 4, left-right direction on paper surface is left-right direction (second direction orthogonal to first direction), left side on paper surface is left side (one side in second direction), and right side on paper surface is right side (the other side in second direction). In FIG. 4, paper-thickness direction is front-rear direction (third direction orthogonal to first direction and second direction), near side on paper surface is front side (one side in third direction), and far side on paper surface is rear side (the other side in third direction). To be specific, directions are in accordance with the direction arrows in the figures. In FIG. 1A-B, the housing is shown as transparent. In FIG. 3A-B, the first insulating cover layer, second insulating cover layer, and third insulating cover layer are omitted.

<Battery Pack>

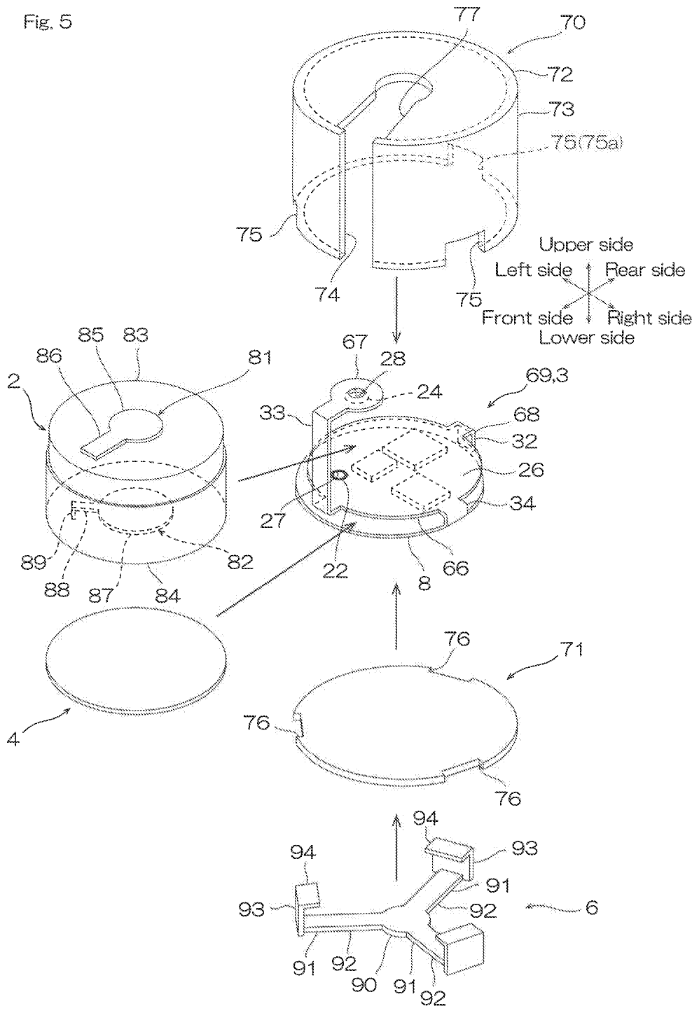

The battery pack in an embodiment of the present invention is described with reference to FIG. 1A-FIG. 7B. As shown FIGS. 1A-B and FIG. 5, the battery pack 1 includes a secondary battery 2, coil-included board 3, magnetic sheet 4, housing 5, and metal member 6. These components are described below.

(Secondary Battery)

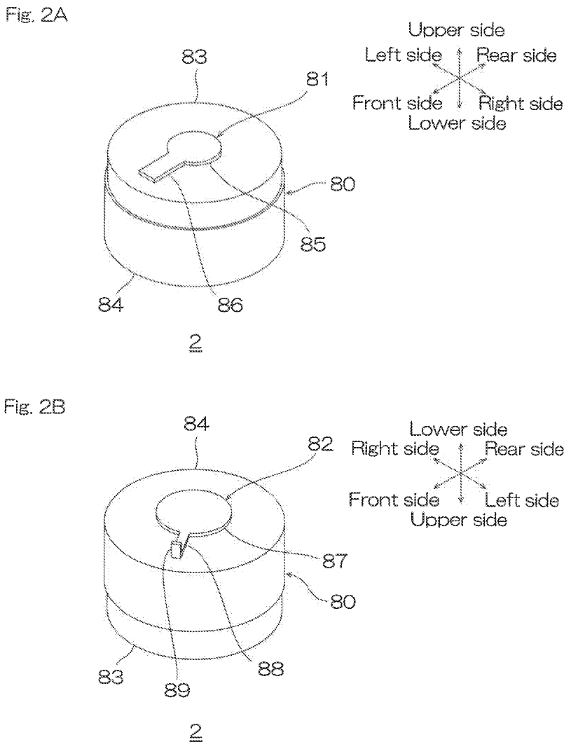

As shown in FIGS. 1A-B and FIGS. 2A-B, the secondary battery 2 is a tabbed secondary battery, and includes a battery main portion 80, negative electrode tab 81, and positive electrode tab 82.

The battery main portion 80 is a secondary battery capable of charging and discharging, and has a generally cylindrical shape (particularly, button shape). The battery main portion 80 is leveled in up-down direction, with its upper portion slightly smaller in diameter than that of the lower portion.

The battery main portion 80 includes a battery negative electrode terminal 83 and a battery positive electrode terminal 84.

The battery negative electrode terminal 83 is disposed at the upper side of the battery main portion 80. To be specific, the battery negative electrode terminal 83 is formed at the upper face of the battery main portion 80, and the peripheral side face of the upper portion.

The battery positive electrode terminal 84 is disposed at the lower side of the battery main portion 80. To be specific, the battery positive electrode terminal 84 is formed at the lower face of the battery main portion 80, and the peripheral side face of the lower portion.

Examples of the battery main portion 80 include, to be specific, a lithium ion secondary battery, nickel hydrogen secondary battery, and silver zinc secondary battery.

The negative electrode tab 81 has a thin plate shape, and is disposed at the upper face (upper side surface) of the battery main portion 80. To be specific, the negative electrode tab 81 is disposed at the upper side of the battery main portion 80 so that the lower face of the negative electrode tab 81 makes contact with the upper face of the battery negative electrode terminal 83.

The negative electrode tab 81 integrally includes a center portion 85 having a generally circular shape in plan view, and an extension portion 86 extending linearly from the center portion 85 to the outside (front side) in radial direction. The center portion 85 of the negative electrode tab 81 overlaps with the center of the battery negative electrode terminal 83 when projected in the thickness direction.

The positive electrode tab 82 has a thin plate shape, and is disposed at the lower face (lower side surface) of the battery main portion 80. To be specific, the positive electrode tab 82 is disposed at lower side of the battery main portion 80 so that the upper face of the positive electrode tab 82 makes contact with the lower face of the battery positive electrode terminal 84.

The positive electrode tab 82 integrally includes a center portion 87 having a generally circular shape in plan view, an extension portion 88 extending linearly from the center portion 87 to the outside (left front side) in the radial direction, and a projection portion 89 extending slightly from one end edge of the extension portion 88 to the lower side. The center portion 87 of the positive electrode tab 82 overlaps with the center of the battery positive electrode terminal 84 when projected in the thickness direction.

Examples of the material for the negative electrode tab 81 and positive electrode tab 82 include electrically conductive metals such as copper, silver, gold, nickel, and alloys thereof.

The negative electrode tab 81 and the positive electrode tab 82 are fixed to the battery main portion 80 by, for example, welding.

In the secondary battery 2, the negative electrode tab 81 and positive electrode tab 82 function as the battery negative electrode terminal and battery positive electrode terminal, respectively.

(Coil-Included Board)

As shown in FIGS. 3A-B (developed view), the coil-included board 3 integrally includes a coil member 8 and circuit board 9.

The coil member 8 is a sheet coil: it is a power-receiving coil that receives electric power supplied from a power-supplying device to be described later. To be specific, it is a power-receiving coil that is capable of generating electricity based on the magnetic field generated by the power-supplying coil to be described later.

As shown in FIG. 4, the coil member 8 includes a first insulating base layer 10, first coil pattern 11, second coil pattern 12, first coil insulating cover layer 13, and second coil insulating cover layer 14.

As shown in FIG. 3A to FIG. 4, the first insulating base layer 10 has the outline shape of the coil member 8, and has a generally circular shape in plan view.

At a generally center in plan view of the first insulating base layer 10, a via opening 15 penetrating in up-down direction (thickness direction) is formed. At the via opening 15, a coil via portion 16 composed of metal conductive portion is disposed. The coil via portion 16 is exposed from the upper face and the lower face of the first insulating base layer 10. The coil via portion 16 is integrally formed with and electrically connects the first coil pattern 11 and the second coil pattern 12.

The first insulating base layer 10 is formed from, for example, insulating materials such as synthetic resin including polyimide resin, polyamide-imide resin, acrylic resin, polyether nitrile resin, polyether sulfone resin, polyethylene terephthalate resin, polyethylene naphthalate resin, and polyvinyl chloride resin. Preferably, it is formed from polyimide resin.

The first insulating base layer 10 has a thickness of, for example, 1 μm or more, preferably 5 μm or more, and for example, 100 μm or less, preferably 60 μm or less.

The first coil pattern 11 is disposed at the upper face of the first insulating base layer 10. To be specific, the first coil pattern 11 is disposed at the upper side of the first insulating base layer 10 so that the lower face of the first coil pattern 11 is brought into contact with the upper face of the first insulating base layer 10. The first coil pattern 11 is a coiled wire pattern composed of wires 17.

As shown in FIG. 3A, the first coil pattern 11 is formed into a swirl shape headed from the coil via portion 16 to the outside in radial direction in plan view. The first coil pattern 11 is formed into a swirl shape reaching the peripheral end near the second joint base portion 34, and at the peripheral end near the second joint base portion 34, it is formed into a linier shape heading toward the outside (left side).

As shown in FIG. 4, the cross sectional shape of the wire 17 forming the first coil pattern 11 along the radial direction is formed into a generally rectangular shape.

The second coil pattern 12 is disposed at the lower face of the first insulating base layer 10. To be specific, the second coil pattern 12 is disposed at the lower side of the first insulating base layer 10 so that the upper face of the second coil pattern 12 is in contact with the lower face of the first insulating base layer 10. The second coil pattern 12 is a coiled wire pattern composed of wires 17.

As shown in FIG. 3B, the second coil pattern 12 is formed into a swirl shape headed from the coil via portion 16 to the outside in radial direction in bottom view. The second coil pattern 12 is formed into a swirl shape reaching the peripheral end near the second joint base portion 34, and at the peripheral end near the second joint base portion 34, it is formed into a linear shape headed toward the outside (left side).

The cross sectional shape of the wire 17 forming the second coil pattern 12 along the radial direction is formed into a generally rectangular shape. Examples of the material forming the wire 17 include conductive metals such as copper, silver, gold, nickel, solder, and alloys thereof. Preferably, copper is used.

The bottom view shape (swirl shape pattern) at the intermediate portion of the second coil pattern 12 is generally the same as the plan view shape at the intermediate portion of the first coil pattern 11. That is, the width L of the wires 17 of the second coil pattern 12 and the space S between the wires 17 are generally the same as the width L and the space S of the wire 17 of the first coil pattern 11, and the number of winding of the second coil pattern 12 is the same as the number of winding of the first coil pattern 11.

In the first coil pattern 11 and second coil pattern 12, the width L (radial direction length of wire 17) of the wire 17 is, for example, 5 μm or more, preferably 20 μm or more, and for example, 400 μm or less, preferably 200 μm or less.

In the first coil pattern 11 and second coil pattern 12, the thickness T of the wire 17 is, for example, 3 μm or more, preferably 10 μm or more, and for example, 200 μm or less, preferably 100 μm or less.

In the first coil pattern 11 and second coil pattern 12, the space S (radial direction distance between the wires 17 adjacent to each other) between the wires 17 is, for example, 5 μm or more, preferably 20 μm or more, and for example, 400 μm or less, preferably 200 μm or less.

In the first coil pattern 11 and second coil pattern 12, the coil is wound by a number of, for example, 1 or more, preferably 3 or more, and for example, 500 or less, preferably 300 or less.

The first coil insulating cover layer 13 is disposed at the upper face of the first coil pattern 11. To be specific, the first coil insulating cover layer 13 is disposed at the upper side of the first coil pattern 11 and first insulating base layer 10 so as to cover the upper face and the side face of the first coil pattern 11, and the upper face of the first insulating base layer 10 exposed from the first coil pattern 11.

The first coil insulating cover layer 13 has a generally circular shape in plan view. When projected in up-down direction, the first coil insulating cover layer 13 includes the first coil pattern 11, and the first coil insulating cover layer 13 is included in the first insulating base layer 10.

The second coil insulating cover layer 14 is disposed at the lower face of the second coil pattern 12. To be specific, the second coil insulating cover layer 14 is disposed at the lower side of the second coil pattern 12 and first insulating base layer 10 so as to cover the lower face and side face of the second coil pattern 12, and the lower face of the first insulating base layer 10 exposed from the second coil pattern 12.

The second coil insulating cover layer 14 has a generally circular shape in plan view. The second coil insulating cover layer 14 includes the second coil pattern 12, and the second coil insulating cover layer 14 is included in the first insulating base layer 10 when projected in up-down direction.

The first coil insulating cover layer 13 and the second coil insulating cover layer 14 are formed from the material that is the same as that of the above-described insulating material for the first insulating base layer 10, and preferably, formed from polyimide resin.

The first coil insulating cover layer 13 and second coil insulating cover layer 14 has a thickness of, for example, 2 μm or more, preferably 5 μm or more, and for example, 70 μm or less, preferably 60 μm or less.

The circuit board 9 is a flexible wired circuit board having flexibility, and is disposed at the left side of the coil member 8 to be continuous therefrom.

The circuit board 9 includes, as shown in FIGS. 3A-B, a second insulating base layer 20, control element 21, battery-side circuit positive electrode terminal 22, external-side circuit positive electrode terminal 23, charging-circuit negative electrode terminal 24, connection wire pattern 25, and third insulating cover layer 26.

The second insulating base layer 20 includes the control circuit base portion 30, negative electrode terminal base portion 31, positive electrode base portion 32, first joint base portion 33, and second joint base portion 34.

The control circuit base portion 30 is an insulating base portion for mounting the control element 21 (described later), and is disposed at a generally center in plan view of the circuit board 9. The control circuit base portion 30 has a generally circular shape in plan view, and is formed to be a slightly smaller than the first insulating base layer 10.

At the control circuit base portion 30, a plurality of base via portions (first to tenth via portions 36 to 45) that electrically connect the connection wire pattern 25 (first to ninth connection wires 50 to 59 to be described later) with the control element 21 (rectifier 47, charge controller 48, transformer 49 to be described later) are formed. To be specific, the following is formed: the first via portion 36 for connecting the rectifier 47 with the first connection wire 50 in up-down direction, second via portion 37 for connecting the rectifier 47 with the second connection wire 51 in up-down direction, third via portion 38 for connecting the rectifier 47 with the third connection wire 52 in up-down direction, fourth via portion 39 for connecting the rectifier 47 with the fifth connection wire 54 in up-down direction, fifth via portion 40 for connecting the charge controller 48 with the third connection wire 52 in up-down direction, sixth via portion 41 for connecting the charge controller 48 with the fourth connection wire 53 in up-down direction, seventh via portion 42 for connecting the charge controller 48 with the ninth connection wire 58 in up-down direction, eighth via portion 43 for connecting the transformer 49 with the sixth connection wire 55 in up-down direction, ninth via portion 44 for connecting the transformer 49 with the seventh connection wire 56 in up-down direction, and tenth via portion 45 for connecting the transformer 49 with the tenth connection wire 59 in up-down direction. At each of the base via portions 36 to 45, a via opening penetrating the second insulating base layer 20 in up-down direction is formed, and the metal conductive portion is disposed at the via opening. The control circuit base portion 30 is formed with a positive electrode terminal opening 27 penetrating the control circuit base portion 30 in the thickness direction at a position corresponding to the battery side circuit positive electrode terminal 22.

The negative electrode terminal base portion 31 is an insulating base portion for disposing the charging-circuit negative electrode terminal 24, and is disposed at the front side of the control circuit base portion 30 in spaced apart relation. The negative electrode terminal base portion 31 has a generally circular shape in plan view, and is formed to be smaller than the control circuit base portion 30. The negative electrode terminal base portion 31 is formed with a negative electrode terminal opening 28 penetrating the negative electrode terminal base portion 31 in the thickness direction at a position corresponding to the charging-circuit negative electrode terminal 24.

The positive electrode base portion 32 is an insulating base portion for providing the battery-side circuit positive electrode terminal 22, and is disposed at a rear side of the control circuit base portion 30. To be specific, the positive electrode base portion 324 is disposed at the rear side of the control circuit base portion 30 so that the front end thereof is integrally continuous with the control circuit base portion 30. The positive electrode base portion 32 is formed into a generally rectangular shape in plan view extending in front-rear direction. The positive electrode base portion 32 is disposed at a position corresponding to a fitted portion 75 (to be specific, fitted portion 75a positioned symmetrically to the slit 74 relative to the center of the main portion 70 in plan view), when the coil-included board 3 is accommodated in the main portion 70 of the housing 5 as a bent circuit 69 (described later).

A single (one) bending portion 60 is formed at a position in front-rear direction of the positive electrode base portion 32. The bending portion 60 extends linearly in left-right direction, from the left end edge to the right end edge. The bending portion 60 can be bent at right angles toward the lower side.

The first joint base portion 33 is an insulating base portion for connecting the control circuit base portion 30 with the negative electrode terminal base portion 31, and is disposed at the front side of the control circuit base portion 30. To be specific, the first joint base portion 33 is disposed between the negative electrode terminal base portion 31 and the control circuit base portion 30 so that the front end thereof is integrally continuous with the negative electrode terminal base portion 31 and the rear end thereof is integrally continuous with the control circuit base portion 30. The first joint base portion 33 is formed into a generally rectangular shape extending in front-rear direction in plan view. The first joint base portion 33 is disposed so as to be accommodated in the slit 74 when the coil-included board 3 is accommodated in the main portion 70 of the housing 5 as the bent circuit 69 (described later).

A plurality of (two) first bending portions 61 are formed in spaced apart relation in front-rear direction at a position in front-rear direction of the first joint base portion 33. The first bending portion 61 extends linearly in left-right direction, from the left end edge to the right end edge. The first bending portion 61 can be bent at right angles toward the upper side.

The second joint base portion 34 is an insulating base portion for connecting the control circuit base portion 30 with the first insulating base layer 10, and is disposed at the right side of the control circuit base portion 30. To be specific, the second joint base portion 34 is disposed between the control circuit base portion 30 and the first insulating base layer 10 so that the left end thereof is integrally continuous with the control circuit base portion 30 and the right end thereof is integrally continuous with the first insulating base layer 10. The second joint base portion 34 is formed into a generally rectangular shape extending in left-right direction in plan view.

Along the left-right direction of the second joint base portion 34, a plurality of (two) second bending portions 62 are formed in spaced apart relation in left-right direction. The second bending portion 62 extends linearly from the front end edge to the rear end edge in front-rear direction. The second bending portion 62 can be bent to form the right angle toward the lower side.

At the second joint base portion 34, an eleventh via portion 46 for connecting the second connection wire 51 and eighth connection wire 57 in up-down direction is formed. At the eleventh via portion 46, a via opening penetrating the second insulating base layer 20 in up-down direction is formed, and the via opening is charged with the metal conductive portion.

The battery-side circuit positive electrode terminal 22 is a terminal for supplying the electric current from the coil member 8 to the battery positive electrode terminal 84 of the secondary battery 2 at the time of charging, and a terminal for supplying the electric current from the battery positive electrode terminal 84 through the external-side circuit positive electrode terminal 23 to the positive electrode terminal (for example, external device positive electrode terminal 117 to be described later) of the external electronic device (for example, hearing aid 110 to be described later) at the time of discharging.

The battery-side circuit positive electrode terminal 22 is disposed to be connectable with the positive electrode tab 82 of the secondary battery 2. To be specific, the battery-side circuit positive electrode terminal 22 is disposed at the upper face and the left front portion of the control circuit base portion 30.

The battery-side circuit positive electrode terminal 22 has a generally circular disc shape in plan view. That is, the battery-side circuit positive electrode terminal 22 is formed at the upper face of the second insulating base layer 20 so as to surround the peripheral edge of the positive electrode terminal opening 27.

The external-side circuit positive electrode terminal 23 is a terminal for supplying the electric current from the secondary battery 2 to the positive electrode terminal of the external electronic device through the metal member 6 at the time of discharging.

The external-side circuit positive electrode terminal 23 is disposed so as to be contactable with the end edge (fitting portion 93 to be described later) of the metal member 6. To be specific, the external-side circuit positive electrode terminal 23 is disposed at the upper face and a generally center in plan view of the positive electrode base portion 32. The external-side circuit positive electrode terminal 23 has a generally circular shape in plan view.

The charging-circuit negative electrode terminal 24 is a terminal for supplying electric current from the coil member 8 to the battery negative electrode terminal 83 of the secondary battery 2 at the time of charging.

The charging-circuit negative electrode terminal 24 is disposed so as to be connectable with the negative electrode tab 81 of the secondary battery 2. To be specific, the charging-circuit negative electrode terminal 24 is disposed at the upper face and a generally center in plan view of the negative electrode terminal base portion 31.

The charging-circuit negative electrode terminal 24 has a generally circular disc shape in plan view. The charging-circuit negative electrode terminal 24 is formed at the upper face of the negative electrode terminal base portion 31 so as to surround the peripheral edge of the negative electrode terminal opening 28.

The connection wire pattern 25 is a wire that electrically connects the terminals (22, 23, 24), coil patterns (11, 12), and control element 21. The connection wire pattern 25 includes a first connection wire 50, second connection wire 51, third connection wire 52, fourth connection wire 53, fifth connection wire 54, sixth connection wire 55, seventh connection wire 56, eighth connection wire 57, ninth connection wire 58, and tenth connection wire 59.

The first connection wire 50 electrically connects the first coil pattern 11 with the rectifier 47. That is, one end of the first connection wire 50 is connected to the first coil pattern 11, and the other end thereof is connected to the first via portion 36. To be specific, the first connection wire 50 is disposed from the right end of the upper face of the second joint base portion 34 to the right end of the upper face of the control circuit base portion 30.

The second connection wire 51 electrically connects the second coil pattern 12 with the rectifier 47 through the eighth connection wire 57 and eleventh via portion 46. That is, one end of the second connection wire 51 is connected to the second via portion 37, and the other end thereof is connected to the eleventh via portion 46. To be specific, the second connection wire 51 is disposed to reach from a generally center of the upper face of the second joint base portion 34 to the right end of the upper face of the control circuit base portion 30, and to be positioned at the front side than the first connection wire 50.

The third connection wire 52 electrically connects the rectifier 47 with the charge controller 48. That is, one end of the third connection wire 52 is connected to the third via portion 38, and the other end thereof is connected to the fifth via portion 40. To be specific, the third connection wire 52 is disposed at generally a center of the upper face of the control circuit base portion 30.

The fourth connection wire 53 electrically connects the charge controller 48 with the battery-side circuit positive electrode terminal 22. That is, one end of the fourth connection wire 53 is connected with the sixth via portion 41, and the other end thereof is connected with the battery-side circuit positive electrode terminal 22. To be specific, the fourth connection wire 53 is disposed from a generally center to the left front side at the upper face of the control circuit base portion 30.

The fifth connection wire 54 electrically connects the rectifier 47 with the charging-circuit negative electrode terminal 24. That is, one end of the fifth connection wire 54 is connected to the fourth via portion 39, and the other end thereof is connected to the charging-circuit negative electrode terminal 24. To be specific, the fifth connection wire 54 is disposed so as to reach generally a center of the upper face of the negative electrode terminal base portion 31 from generally a center of the upper face of the control circuit base portion 30 through the first joint base portion 33.

The sixth connection wire 55 electrically connects the battery-side circuit positive electrode terminal 22 with the transformer 49. That is, one end of the sixth connection wire 55 is connected to the battery-side circuit positive electrode terminal 22, and the other end thereof is connected to the eighth via portion 43. To be specific, the sixth connection wire 55 is disposed at the left side of the upper face of the control circuit base portion 30.

The seventh connection wire 56 electrically connects the transformer 49 with the external-side circuit positive electrode terminal 23. That is, one end of the seventh connection wire 56 is connected to the ninth via portion 44, and the other end thereof is connected to the external-side circuit positive electrode terminal 23. To be specific, the seventh connection wire 56 is disposed to reach generally a center and the upper face of the positive electrode base portion 32 from the rear end of the upper face of the control circuit base portion 30.

The eighth connection wire 57 electrically connects the second coil pattern 12 with the rectifier 47 through the second connection wire 51 and the eleventh via portion 46. That is, one end of the eighth connection wire 57 is connected to the second coil pattern 12, and the other end thereof is connected to the eleventh via portion 46. To be specific, the eighth connection wire 57 is disposed so as to reach the right end from generally a center at the lower face of the second joint base portion 34.

The ninth connection wire 58 electrically connects the charge controller 48 with the charging-circuit negative electrode terminal 24. That is, one end of the ninth connection wire 58 is connected to the seventh via portion 42, and the other end thereof is connected to the charging-circuit negative electrode terminal 24. To be specific, the ninth connection wire 58 is disposed to reach generally a center of the upper face of the negative electrode terminal base portion 31 from generally a center of the upper face of the control circuit base portion 30 through the first joint base portion 33.

The tenth connection wire 59 electrically connects the transformer 49 with the charging-circuit negative electrode terminal 24. That is, one end of the tenth connection wire 59 is connected to the tenth via portion 45, and the other end thereof is connected to the charging-circuit negative electrode terminal 24. To be specific, the tenth connection wire 59 is disposed to reach generally a center of the upper face of the negative electrode terminal base portion 31 from the rear end of the upper face of the control circuit base portion 30 through the first joint base portion 33.

For the material of the connection wire pattern 25, those materials given as examples for the wire 17 are used. Preferably, copper is used.

The connection wire pattern 25 has a thickness of, for example, 3 μm or more, preferably 10 μm or more, and for example, 200 μm or less, preferably 100 μm or less.

The control element 21 is an element that controls the electric power flowing in the connection wire pattern 25 at the time of charging and discharging. The control element 21 includes a rectifier 47, charge controller 48, and transformer 49.

The rectifier 47 is an element that converts the alternating current supplied from the coil member 8 to the direct current (AC/DC converter) at the time of charging. The rectifier 47 is disposed at the lower face of the control circuit base portion 30, and in bottom view, disposed at the right side of the control circuit base portion 30. The rectifier 47 electrically connects the first connection wire 50, second connection wire 51, third connection wire 52, and fifth connection wire 54.

The charge controller 48 is an element that controls the electric power converted to the direct current at the rectifier 47 and supplied to the battery-side circuit positive electrode terminal 22 at the time of charging. The charge controller 48 includes, as necessary, a communication function that monitors charging status of the secondary battery 2, produces a transmission signal, and transmits it to the power-supplying device 101 (described later). The charge controller 48 is disposed at the lower face of the control circuit base portion 30, and in bottom view, disposed at generally a center of the control circuit base portion 30. The charge controller 48 electrically connects the third connection wire 52, fourth connection wire 53, and ninth connection wire 58.

The transformer 49 is an element that adjusts the voltage from the secondary battery 2 at the time of discharging. The transformer 49 is disposed at the lower face of the control circuit base portion 30, and in bottom view, disposed at the rear side of the control circuit base portion 30. The transformer 49 is electrically connected with the sixth connection wire 55 and seventh connection wire 56.

The third insulating cover layer 26 is, as shown in FIG. 5, disposed at the upper side of the second insulating base layer 20 in correspondence with the connection wire pattern 25. To be specific, the third insulating cover layer 26 is disposed at the upper face of the second insulating base layer 20 so as to cover the connection wire pattern 25 and via portion (36 to 46), and expose the upper face of the battery-side circuit positive electrode terminal 22, external-side circuit positive electrode terminal 23, and charging-circuit negative electrode terminal 24.

The material and the thickness of the third insulating cover layer 26 are the same as those of the first insulating base layer 10.

Such a coil-included board 3 can be produced by, for example, integrally producing the circuit board 9 excluding the coil member 8 and the control element 21, and then mounting the control element 21 on the circuit board 9.

To be specific, by subtractive method or additive method, on the upper face of the insulating base layers (10, 20), the first coil pattern 11, connection wire pattern 25, battery-side circuit positive electrode terminal 22, external-side circuit positive electrode terminal 23, and charging-circuit negative electrode terminal 24 are formed, and at the lower face of the insulating base layer, the second coil pattern 12 is formed. The via portions (16, 36 to 46) are also formed simultaneously with those.

Then, the first coil insulating cover layer 13 is formed on the upper face of the first insulating base layer 10 so as to cover the first coil pattern 11. The second coil insulating cover layer 14 is formed on the lower face of the second insulating base layer 20 so as to cover the second coil pattern 12. The third insulating cover layer 26 is formed so as to cover the connection wire pattern 25 and the via portions 36 to 46, and expose the battery-side circuit positive electrode terminal 22, external-side circuit positive electrode terminal 23, and charging-circuit negative electrode terminal 24.

Then, at the lower face of the control circuit base portion 30, the control element 21 (rectifier 47, charge controller 48, and transformer 49) is mounted on corresponding base via portions 36 to 45 through solder.

In the circuit board 9, the control circuit base portion 30; and the control element 21, battery-side circuit positive electrode terminal 22, connection wire pattern 25, and third insulating cover layer 26 disposed on the upper face and lower face thereof compose the control circuit unit 66. The negative electrode terminal base portion 31; and the charging-circuit negative electrode terminal 24, connection wire pattern 25, and third insulating cover layer 26 disposed at the upper face thereof compose the negative electrode terminal unit 67. The positive electrode base portion 32; and the external-side circuit positive electrode terminal 23, connection wire pattern 25, and third insulating cover layer 26 disposed on the upper face thereof compose a positive electrode terminal unit 68.

(Magnetic Sheet)

As shown in FIG. 5, the magnetic sheet 4 has a generally circular flat plate shape in plan view, and is formed into about the same size and shape as those of the coil member 8 in plan view.

The magnetic sheet 4 is a sheet containing magnetic substance, and for example, a magnetic substance particles-containing resin sheet, and sintered magnetic substance sheet are used.

The magnetic substance particles-containing resin sheet is formed into a sheet shape from a composition containing magnetic substance particles and a resin component.

Examples of the magnetic substance forming the magnetic substance particles include soft magnetic substance and hard magnetic substance, and preferably, soft magnetic substance is used.

Examples of the soft magnetic substance include magnetic stainless steel (Fe—Cr—Al—Si alloy), Sendust (Fe—Si—Al alloy), permalloy (Fe—Ni alloy), silicon copper (Fe—Cu—Si alloy), Fe—Si alloy, Fe—Si—B (—Cu—Nb) alloy, Fe—Si—Cr—Ni alloy, Fe—Si—Cr alloy, Fe—Si—Al—Ni—Cr alloy, and ferrite.

Examples of the resin component include rubber polymers such as butadiene rubber, styrene-butadiene rubber, isoprene rubber, acrylonitrile rubber, poly acrylate, ethylene-vinyl acetate copolymer, and styrene acrylate copolymer. Examples of the resin component include, in addition to the above-described ones, thermosetting resin such as epoxy resin, phenol resin, melamine resin, and urea resin, and thermoplastic resin such as polyolefin, polyvinyl acetate, polyvinyl chloride, polystyrene, polyamide, polycarbonate, and polyethylene terephthalate.

The sintered magnetic substance sheet is the above-described magnetic substance sintered into a sheet, and for example, a ferrite sheet is used.

The magnetic sheet 4 has a thickness of, for example, 10 μm or more, preferably 50 μm or more, and for example, 500 μm or less, preferably 300 μm or less.

(Housing)

As shown in FIGS. 1A-B and FIG. 5, the housing 5 has a generally cylindrical shape extending in up-down direction, and includes a main portion 70 and a lid 71.

The main portion 70 integrally includes an upper plate 72 having a circular plate shape and a cylindrical portion 73 having a cylindrical shape, and has a bottomed cylindrical shape with its lower side opened.

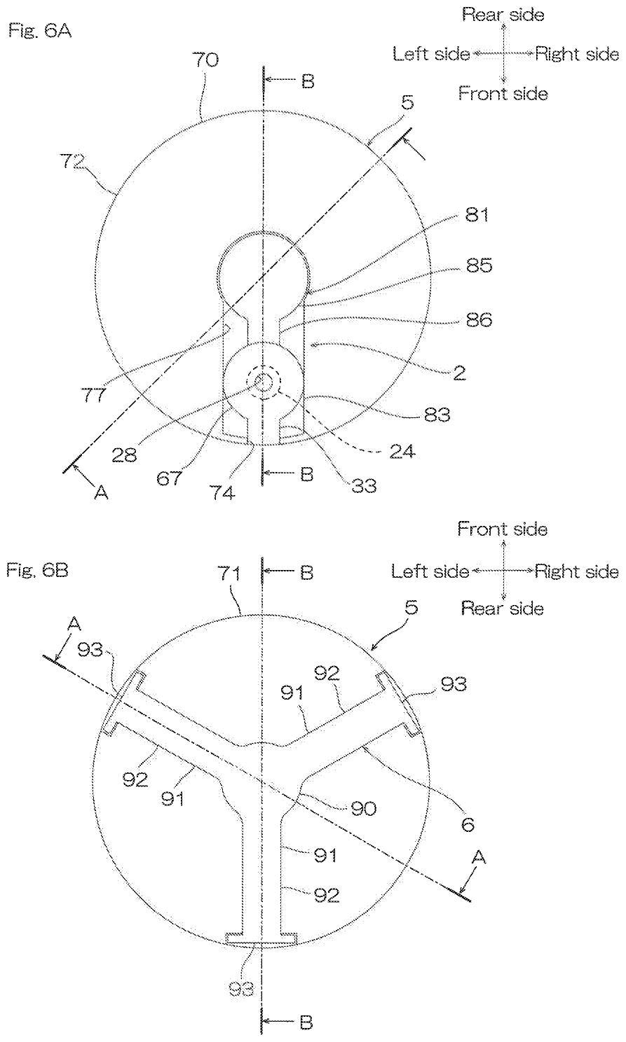

The upper plate 72 is formed with an upper face opening 77. As shown in FIG. 6A, the upper face opening 77 is formed so as to accommodate the negative electrode tab 81 and the negative electrode terminal unit 67 when the secondary battery 2, coil-included board 3, and magnetic sheet 4 are accommodated in the housing 5. To be specific, the upper face opening 77 is formed so as to cut out from the peripheral end portion of the main portion 70 to a center in the radial direction into a generally U-shape.

A slit 74 is formed at a front side face of the cylindrical portion 73 so as to communicate with the upper face opening 77. The slit 74 is formed so as to accommodate the first joint base portion 33 when the secondary battery 2, coil-included board 3, and magnetic sheet 4 are accommodated in the housing 5. To be specific, the slit 74 is formed into a rectangular shape when viewed from the side extending in up-down direction from the lower end edge to the upper end edge of the front side of the cylindrical portion 73.

A plurality of (three) fitted portions 75 are formed at a lower end portion of the cylindrical portion 73.

The plurality of (three) fitted portions 75 are formed so as to fit with a plurality of (three) fitting portions 93 of the metal member 6 to be described later. To be specific, the plurality of fitted portion 75 are formed at a lower end edge of the main portion 70 in spaced apart relation to each other in equal distance in circumferential direction. The fitted portion 75 are formed so as to be cut out into a generally rectangular shape in side view from the lower end edge to the upper side of the main portion 70.

The lid 71 has a generally circular plate shape. As shown in FIG. 5 and FIG. 6B, a plurality of (three) cutout portions 78 are formed at a peripheral end edge of the lid 71. The plurality of cutout portions 78 are formed at positions corresponding to the plurality of fitted portions 75 when the lid 71 is fixed to the main portion 70. To be specific, the plurality of cutout portions 78 are formed at the peripheral end edge of the lid 71 in spaced apart relation from each other to be equal distance in circumferential direction. The cutout portions 78 are formed into a generally rectangular shape in plan view along the circumferential direction.

(Metal Member)

As shown in FIG. 5 and FIG. 6B, the metal member 6 integrally includes a center portion 90 and a plurality of (three) strip portions 91. The metal member 6 is formed into a propeller shape, with the plurality of (three) strip portions 91 extending radially from the center portion 90.

The center portion 90 is disposed at a generally center in plan view of the metal member 6, and has a generally circular plate shape in plan view.

The plurality of (three) strip portions 91 extend along the surface direction (front-rear direction and left-right direction) from the center portion 90 toward outside in radial direction. The plurality of strip portions 91 extend radially from the center portion 90. That is, the plurality of strip portions 91 extend from the center portion 90 toward a direction (to be specific, direction forming an angle of 120 degrees) different from each other.

The plurality of strip portions 91 each integrally includes an extension portion 92, a fitting portion 93 as an end edge, and a hook 94.

The extension portion 92 is formed into a linear shape so that the inner end edge is integrally continuous with the center portion 90, and the outer end edge is integrally continuous with the fitting portion 93.

The fitting portion 93 is formed so as to be disposed at the outer end edge of the extension portion 92, and to extend from the outer end edge to the upper side of the extension portion 92.

The fitting portion 93 is formed into a generally rectangular shape in side view with its width larger than the extension portion 92.

The hook 94 is formed so as to head from the upper end of the fitting portion 93 toward the inner side in radial direction. The hook 94 is formed into a generally rectangular shape in plan view with its width being the same as the width of the fitting portion 93.

The upper face of the hook 94 is insulated. The upper face of the book 94 is insulated by, for example, providing an insulating sheet thereon.

Examples of the material for the metal member 6 include electrically conductive metals such as copper, silver, gold, nickel, SUS, and alloys thereof. In view of its non-susceptible to deformation, and excellent electrical conductivity, preferably, copper is used.

The metal member 6 has a thickness of, for example, 50 μm or more, preferably 100 μm or more, and for example, 1000 μm or less, preferably 500 μm or less.

(Battery Pack)

The battery pack 1 assembly is described next.

As shown in FIG. 5, first, the coil-included board 3 shown in FIGS. 3A-B is bent so that it can be accommodated in the housing 5.

To be specific, in the coil-included board 3 shown in FIG. 3A, the two first bending portions 61 of the first joint base portion 33 are bent to the upper side to form the right angle (fold to form valley), to dispose the negative electrode terminal base portion 31 above the control circuit base portion 30. The two second bending portions 62 of the second joint base portion 34 are bent to the lower side to form the right angle (fold to form mountain), to dispose the coil member 8 below the control circuit base portion 30. Then, the bending portion 60 of the positive electrode base portion 32 is bent to the lower side to form the right angle (fold to form mountain), to dispose the positive electrode base portion 32 to the side (rear side) of the control element 21.

As shown in FIG. 5, in this manner, a bent circuit 69 including the following is produced: the coil member 8, control circuit unit 66, and negative electrode terminal unit 67 are disposed in spaced apart relation sequentially from the lower side, and the positive electrode terminal unit 68 is disposed at a side of the control element 21.

In the bent circuit 69, the first coil pattern 11 of the coil member 8, control element 21 of the control circuit unit 66, and charging-circuit negative electrode terminal 24 of the negative electrode terminal unit 67 are disposed to face the lower side. The second coil pattern 12 of the coil member 8, and connection wire pattern 25 and battery-side circuit positive electrode terminal 22 of the control circuit unit 66 are disposed to face the upper side. The external-side circuit positive electrode terminal 23 of the positive electrode terminal unit 68 is disposed to face the outside of the housing 5 at the rear side.

The coil member 8, control circuit unit 66, and negative electrode terminal unit 67 are disposed to be parallel to the surface direction (front-rear direction and left-right direction), and the positive electrode base portion 32 (positive electrode terminal unit 68), first joint base portion 33, and second joint base portion 34 are disposed to extend in up-down direction.

Then, as shown in FIG. 5, the secondary battery 2 is disposed between the control circuit unit 66 and the negative electrode terminal unit 67.

That is, the secondary battery 2 is disposed so that the battery negative electrode terminal 83 is disposed at the upper side, and the battery positive electrode terminal 84 is disposed at the lower side. To be specific, the secondary battery 2 is disposed between the control circuit unit 66 and the negative electrode terminal unit 67 so that the charging-circuit negative electrode terminal 24 is in contact with the negative electrode tab 81, and the battery-side circuit positive electrode terminal 22 is in contact with the positive electrode tab 82. At this time, the projection portion 89 of the positive electrode tab 82 is disposed to penetrate the positive electrode terminal opening 27, and the extension portion 86 of the negative electrode tab 81 is disposed to overlap with the negative electrode terminal opening 28 when projected in the thickness direction.

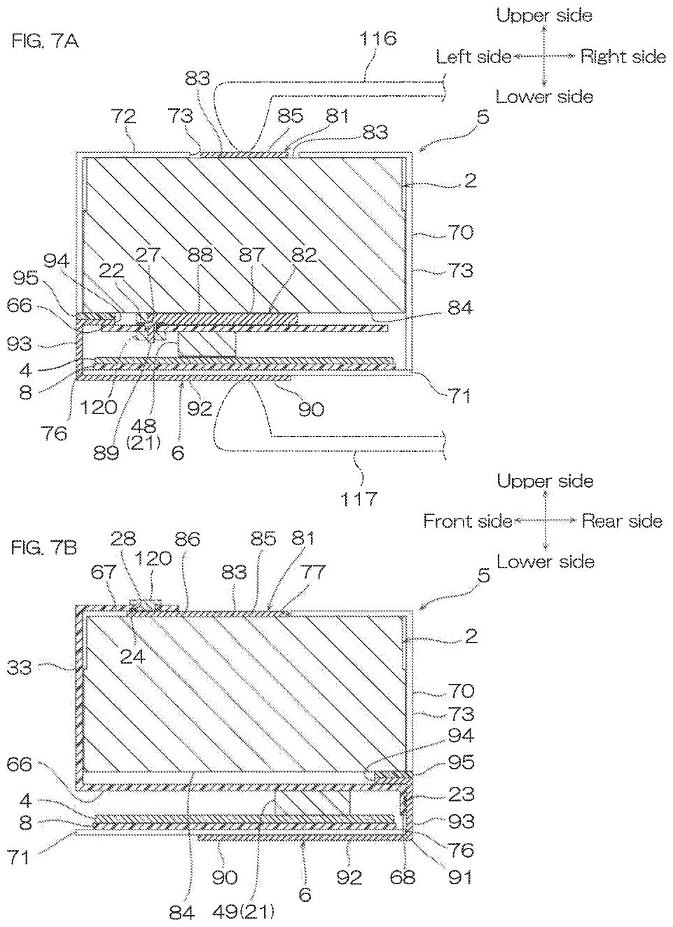

Thereafter, an electrically conductive bonding material 120 (shown by phantom line in FIGS. 7A-B) such as solder is charged in the positive electrode terminal opening 27 and negative electrode terminal opening 28.

Furthermore, the magnetic sheet 4 is disposed between the coil member 8 and the control circuit unit 66.

Then, the bent circuit 69 in which the secondary battery 2 and the magnetic sheet 4 are disposed is accommodated in the main portion 70.

At this time, the bent circuit 69 is accommodated in the main portion 70 so that the slit 74 of the main portion 70 accommodates the first joint base portion 33. The positive electrode base portion 32 (positive electrode terminal unit 68) is disposed at a position corresponding to the fitted portion 75a of the main portion 70, and is exposed from the fitted portion 75a.

Then, the lid 71 is attached to the main portion 70 and they are fixed.

To be specific, the lid 71 is disposed to the main portion 70 so that the plurality of (three) cutout portions 78 of the lid 71 match the plurality of (three) fitted portions 75 of the main portion 70. Then, as necessary, the lid 71 and the main portion 70 are fixed using a fixing member such as an adhesive.

Then, the metal member 6 is attached to the housing 5, and they are fixed.

To be specific, the metal member 6 is disposed below the housing 5 so that the plurality of (three) fitting portions 93 of the metal member 6 fit the plurality of (three) fitted portions 75 of the main portion 70 and the plurality of (three) cutout portions 78 of the lid 71.

At this time, an insulating layer 95 (ref: FIGS. 7A-B) is disposed between the upper face of the hook 94 and the lower face of the secondary battery 2 (battery positive electrode terminal 84).

Then, the hook 94 is inserted inside the housing 5 so that lower end face of the fitted portion 75 of the battery positive electrode terminal 84 and the main portion 70 are placed on the upper face of the hook 94 through the insulating layer 95, and that the lower face of the hook 94 is in contact with the upper face of the control circuit unit 66.

That is, when the metal member 6 includes the hook 94, the battery pack 1 further includes, as necessary, in addition to the metal member 6, the insulating layer 95. Examples of the insulating layer 95 include the above-described sheet composed of a resin component, and an adhesive tape. Instead of disposing the insulating layer 95, a metal member 6 coated with an insulating layer can be used on the upper face of the hook 94.

The external-side circuit positive electrode terminal 23 of the positive electrode terminal unit 68 is brought into contact with the inner side face of the fitting portion 93 of the metal member 6.

In this manner, as shown in FIG. 1 and FIGS. 6A-FIG. 7B, the battery pack 1 is produced.

In the battery pack 1, the secondary battery 2, coil-included board 3, and magnetic sheet 4 are accommodated in the housing 5. To be specific, in the housing 5, the coil member 8, magnetic sheet 4, control circuit unit 66, secondary battery 2, and negative electrode terminal unit 67 are disposed in sequence from the bottom, and the positive electrode terminal unit 68 is disposed at the rear side of the control element 21.

The coil member 8 is disposed so that the first coil pattern 11 is positioned at the lower side, and the second coil pattern 12 is positioned at the upper side.

The control circuit unit 66 is disposed so that the control element 21 is positioned at the lower side, and the battery-side circuit positive electrode terminal 22 and connection wire pattern 25 are positioned at the upper side. The upper face of the control circuit unit 66 is in contact with the lower face of the center portion 87 and the extension portion 88 of the positive electrode tab 82. In the control circuit unit 66, the upper face of the battery-side circuit positive electrode terminal 22 is in contact with the lower face of the extension portion 88, and the projection portion 89 of the positive electrode tab 82 is inserted into the positive electrode terminal opening 27, and the positive electrode terminal opening 27 is filled with the electrically conductive bonding material 120. In this manner, the battery-side circuit positive electrode terminal 22 is electrically connected with the positive electrode tab 82.

The negative electrode terminal unit 67 is disposed at the upper side of the secondary battery 2 so that the charging-circuit negative electrode terminal 24 is positioned at the lower side. The negative electrode terminal unit 67 is disposed so as to be accommodated in the upper face opening 77. That is, the negative electrode terminal unit 67 is included in the upper face opening 77 when projected in up-down direction, front-rear direction, and left-right direction.

The lower face of the negative electrode terminal unit 67 is in contact with the upper face of the extension portion 86 of the negative electrode tab 81, and the negative electrode terminal opening 28 is charged with the electrically conductive bonding material 120. In this manner, the charging-circuit negative electrode terminal 24 is electrically connected with the negative electrode tab 81.

The positive electrode terminal unit 68 is disposed at the rear side of the control element 21 so that the external-side circuit positive electrode terminal 23 is positioned outside. The positive electrode terminal unit 68 is disposed so as to be exposed from the fitted portion 75a. That is, when projected in radial direction, the negative electrode terminal unit 67 is included in the fitted portion 75a. The external side face of the positive electrode terminal unit 68 is in contact with the internal side face of the fitting portion 93 of the metal member 6. That is, the external-side circuit positive electrode terminal 23 is in contact with the metal member 6. In this manner, the external-side circuit positive electrode terminal 23 is electrically connected with the metal member 6.

The first joint base portion 33 of the coil-included board 3 is disposed at a center in up-down direction of the negative electrode terminal unit 67 and control circuit unit 66 to be accommodated in the slit 74 of the main portion 70. That is, when projected in up-down direction, and radial direction (front-rear direction), the first joint base portion 33 is included in the slit 74. The inner face of the first joint base portion 33 is in contact with the front peripheral side of the secondary battery 2.

The second joint base portion 34 is disposed to be in contact with the inner side of the right end of the main portion 70 at a center in up-down direction of the coil member 8 and control circuit unit 66.

The secondary battery 2 is disposed at the upper side of the control circuit unit 66 and the lower side of the negative electrode terminal unit 67. The upper face of the secondary battery 2 (negative electrode tab 81) is in contact with the charging-circuit negative electrode terminal 24 of the negative electrode terminal unit 67, and the lower face of the secondary battery 2 (positive electrode tab 82) is in contact with the battery-side circuit positive electrode terminal 22 of the control circuit unit 66. In this manner, the battery negative electrode terminal 83 is electrically connected with the charging-circuit negative electrode terminal 24, and the battery positive electrode terminal 84 is electrically connected with the battery-side circuit positive electrode terminal 22. The peripheral side face of the secondary battery 2 is in contact with the inner side of the main portion 70.

The metal member 6 is disposed at a lower side of the housing 5. To be specific, the metal member 6 is disposed at a lower side of the lid 71 so that the center portion 90 and the upper face of the plurality of (three) strip portions 91 are in contact with the lower face of the lid 71.

The center portion 90 overlaps with the center of the secondary battery 2 and the housing 5 when projected in the thickness direction.

At the plurality of strip portions 91, the plurality of (three) extension portions 92 extend from the inner side (center in radial direction) of the housing 5 toward the peripheral end edge and are connected to each other at the center portion 90 inside the housing 5 when projected in the thickness direction. Of the plurality of (three) extension portions 92, at least one is disposed at one section (first semi-arc region), and at least one is disposed at the other section (second arc region) when sectioned into two by a straight line passing through a center point of the lid 71, that is, when sectioned equally into a first semi-arc region and a second semi-arc region. To be more specific, the plurality of extension portions 92 are disposed to form an angle of 120 degrees at the center portion 90.

The plurality of (three) fitting portions 93 are positioned at a peripheral end edge of the lower side of the lid 71. The plurality of fitting portions 93 fit the plurality of fitted portions 75 and cutout portion 78 corresponding therewith. That is, the fitting portion 93 is accommodated with the fitted portion 75 and the cutout portion 78. In this manner, the plurality of (three) fitting portions 93 each is position defined at the different fitted portion 75 of the plurality of (three) fitted portions 75.

“The end edge of the metal member 6 is position defined at the peripheral end edge of the housing 5” refers to the following: the position of the end edge of the metal member 6 is fixed relative to the position of the peripheral end edge of the housing 5. The position adjustment includes the case where the position of the end edge of the metal member 6 does not completely move relative to the position of the peripheral end edge of the housing 5, and also the case where the position of the end edge of the metal member 6 moves to an extent of allowed wobbling (for example, the extent of buffer by position adjustment means) relative to the position of the peripheral end edge of the housing 5. For example, when the fitted portion 75 is larger than the fitting portion 93, the fitting portion 93 moves inside the fitted portion 75, and this is regarded as it is position defined.

The hook 94 is disposed at a center in up-down direction of the secondary battery 2 and the control circuit unit 66. To be specific, the hook 94 is positioned at a lower side of the secondary battery 2 and the fitted portion 75, and an upper side of the control circuit unit 66.

In plan view of the battery pack 1, the center portion 85 of the negative electrode tab 81 is exposed from the upper face opening 77, and in bottom view, the center portion 90 of the metal member 6 is disposed at a lower side of the housing 5. In this manner, as shown by the phantom line of FIG. 7A, in the upper face opening 77, the negative electrode terminal 116 of an external electronic device can directly contact the negative electrode tab 81, and at a lower side of the housing 5, the positive electrode terminal 117 of an external device can directly contact the metal member 6.

The position of the center portion 85 of the negative electrode tab 81 in up-down direction is the same as the position of the upper face of the upper plate 72 of the main portion 70 in up-down direction. That is, the upper face of the center portion 85 is flush with the upper face of the upper plate 72.

<Wireless Power Transmission System>

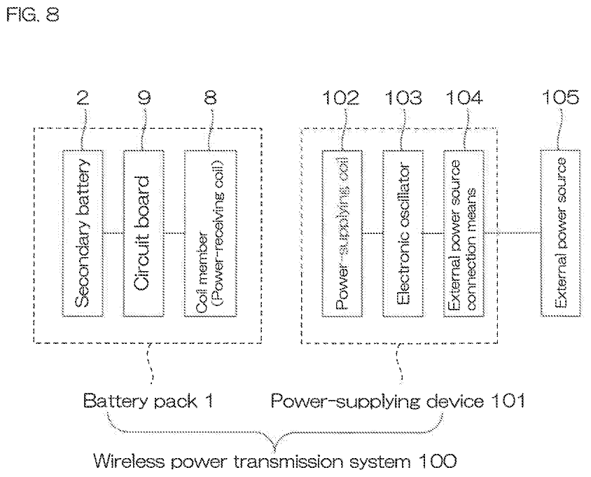

Next, an embodiment of the wireless power transmission system of the present invention is described with reference to FIG. 8.

The wireless power transmission system 100 includes a battery pack 1 and a power-supplying device 101.

The power-supplying device 101 includes a power-supplying coil 102, electronic oscillator 103, and external power source connection means 104.

For the power-supplying coil 102, for example, the above-described coil member 8, and a wound coil formed by winding wire rods such as copper wire is used.

The electronic oscillator 103 is a circuit that generates electric power having a frequency of, for example, 1 MHz or more and 10 MHz or less (preferably 1 MHz or more and 5 MHz or less).

The electronic oscillator 103 can be any of those used for an LC electronic oscillator, CR electronic oscillator, liquid crystal electronic oscillator, and switching circuit.

The external power source connection means 104 is a means that is capable of connecting with the external power source 105, and for example, an AC adapter, and USB terminal are used.

Transmission of the electric power by magnetic field between the coil member 8 (power-receiving coil) and power-supplying coil 102 can be done by any of the magnetic field resonance method and electromagnetic induction method. Preferably, in view of longer transmission distance, and highly efficient electric power transmission even with coil misposition, the magnetic field resonance method is used.

<Charge-Discharge Mechanism>

(At the Time of Charging)

The electric power supplied to the electronic oscillator 103 by the external power source 105 is converted to electric power having a frequency of, for example, 1 MHz or more and 10 MHz or less, and with the electric power of that frequency, magnetic field is generated from the power-supplying coil 102. By the magnetic field generated by the power-supplying coil 102, the coil member 8 (power-receiving coil) receives electric power of that frequency.

The received electric power is converted to direct current and controlled to a voltage of a predetermined value or less by the control element 21, and supplied to the secondary battery 2.

That is, alternating current of 1 MHz or more and 10 MHz or less is generated at the coil member 8, and the alternating current is converted to the direct current by the rectifier 47 through the first connection wire 50 and second connection wire 51. Then, the direct current reaches the charge controller 48 through the third connection wire 52. Thereafter, the direct current controlled by the charge controller 48 reaches the battery positive electrode terminal 84 of the secondary battery 2 through the fourth connection wire 53, battery-side circuit positive electrode terminal 22, and positive electrode tab 82. Meanwhile, at the negative electrode side, the electric current reaches the charge controller 48 from the negative electrode tab 81 of the secondary battery 2 and battery negative electrode terminal 83 (ground) of the secondary battery 2 through the charging-circuit negative electrode terminal 24 and ninth connection wire 58.

In this manner, the secondary battery 2 is charged.

(At the Time of Discharging)

Electric current having a predetermined voltage (for example, 3.7 V) is discharged from the battery positive electrode terminal 84 of the secondary battery 2, and the electric current reaches the transformer 49 through the battery-side circuit positive electrode terminal 22 and sixth connection wire 55. Then, the electric current having a predetermined voltage is transformed to a desired voltage (for example, 1.2 V) by a transformer 49. Thereafter, the transformed electric current reaches the positive electrode terminal (for example, external device positive electrode terminal 117 to be described later) of the external electronic device (for example, hearing aid 110 to be described later) through the seventh connection wire 56, external-side circuit positive electrode terminal 23, and metal member 6. Meanwhile, at the negative electrode side, the negative electrode tab 81 and battery negative electrode terminal 83 of the secondary battery 2 are in direct contact with the negative electrode terminal (for example, external device negative electrode terminal 116 to be described later) of the external electronic device, and therefore the electric current directly reaches the negative electrode tab 81 and battery negative electrode terminal 83 (ground) from the external electronic device, and then the electric current reaches the transformer 49 through the charging-circuit negative electrode terminal 24 and tenth connection wire 59.

In this manner, the secondary battery 2 is discharged to drive the external electronic device.

(Use)

The battery pack 1 and wireless power transmission system 100 can be widely used for electronic devices in which conventional secondary batteries and primary batteries are used. Examples of the electronic device include wearable devices such as hearing aids, smart glasses, and smart watches; speakers; and medical devices.

The battery pack 1 includes a secondary battery 2, a coil member 8, a wired circuit board 9, a housing 5, and a metal member 6. The metal member 6 extends from the inner side (radial direction center) of the housing 5 toward the peripheral end edge along the surface direction (front-rear direction and left-right direction), and has a plurality of strip portions 91 connected to each other through the center portion 90 inside the housing 5. The plurality of strip portions 91 each has a fitting portion 93 positioned at the peripheral end edge of the housing 5, and the plurality of fitting portions 93 each is position defined at the plurality of fitted portions 75.

Thus, the metal member 6 is disposed at a lower side of the housing 5, and is electrically connected with the external-side circuit positive electrode terminal 23 of the wired circuit board 9, and therefore works as the positive electrode terminal. The metal member 6 (positive electrode terminal) is disposed at lower outside of the housing 5, and the coil member 8 is disposed inside the housing 5. Therefore, the metal member 6 is not limited by the position of the coil member 8. That is, the positive electrode terminal does not have to be designed to be provided at a corner in the surface direction so as to avoid the coil member 8. That is, the metal member 6 (terminal) can be disposed at a position in the surface direction where the positive electrode terminal of the electronic device (for example, positive electrode terminal 117 of hearing aid 110 to be described later) can easily make contact. Thus, the battery pack 1 can easily make contact with the positive electrode terminal of the electronic device, and therefore it can be attached to the electronic device smoothly.

The fitting portions 93 of the metal member 6 each is position defined at a plurality of (three) different fitted portions 75. Thus, the metal member 6, i.e., terminal, is fixed stably at a plurality of positions to the housing 5 with the plurality of (three) fitting portions 93. That is, the metal member 6 is a structure that is strong against the pressure toward the inside (upper side) of the secondary battery 2 and the pressure to the surface direction. Thus, while making contact with the positive electrode terminal of the electronic device, the metal member 6 cannot be easily deformed by the pressure and impact from the positive electrode terminal of the electronic device. As a result, connection reliability with the electronic device is excellent.

With the battery pack 1, the metal member 6 is electrically connected with the external-side circuit positive electrode terminal 23 of the wired circuit board 9 at the fitting portion 93 (end edge) of the strip portion 91.

Thus, no lining of wires for electrically connecting the wired circuit board 9 with the metal member 6 is necessary between the coil member 8 and the metal member 6. Therefore, effects on the magnetic field (magnetic field at the time of power supply) between the power-supplying coil 102 of the power-supplying device 101 and the coil member 8 of the battery pack 1 from the electric current flowing in the wire between the wired circuit board and the metal member or magnetic field generating therefrom can be suppressed. Therefore, decline in power supply efficiency can be suppressed.

The battery pack 1 has three strip portions 91.

Thus, the metal member 6 can be position defined with the housing 5 with three fitting portions 93. Thus, the metal member 6 allows for more stable fixing to the housing 5, and connection reliability can be improved even more.

The metal member 6 includes a center portion 90 overlapping with the center of the secondary battery 2 when projected in the thickness direction, and the strip portion 91 extends radially from the center portion 90.

Thus, the positive electrode terminal of the electronic device can make contact with the metal member 6 (center portion 90) more easily. Thus, connection reliability can be improved even more.

Furthermore, when projected in the thickness direction, the center portion 90 of the metal member 6 overlaps with the center portion 85 of the negative electrode tab 81, and positioned at a center of the secondary battery 2. That is, these center portions are present on one straight line passing through the center of the secondary battery 2. Thus, two terminals (positive electrode terminal and negative electrode terminal) of the electronic device can be easily and stably allowed to contact the center portion 90 of the metal member 6 and the center portion 85 of the negative electrode tab 81.

The strip portion 91 has a fitting portion 93 at its end edge, and the housing 5 has a fitted portion 75 at its peripheral end edge.

Thus, the metal member 6 can fit the peripheral end edge of the housing 5, and therefore the metal member 6 can be fixed strongly with the housing 5.

In the battery pack 1, the fitting portion 93 of the strip portion 91 includes a hook 94 extending inward from the distal end of the fitting portion 93.

Thus, the hook 94 is positioned below the main portion 70 of the housing 5 and the secondary battery 2, and therefore the hook 94 can press or support the main portion 70 and the secondary battery 2 to the upper side. Thus, the secondary battery 2 can be suppressed from deformation of the coil-included board 3 (flexible board) and movement to the lower side, and generation of gaps between the lower face of the upper plate 72 and upper face of the secondary battery 2 can be suppressed. As a result, the secondary battery 2 wobbling can be suppressed in the housing 5. The hook 94 can be disposed between the secondary battery 2 and the control circuit unit 66, and therefore the metal member 6 can be suppressed from falling from the battery pack 1.

The secondary battery 2 includes the positive electrode tab 82 and the negative electrode tab 81.

Thus, through the positive electrode tab 82 and the electrically conductive bonding material 120, the battery-side circuit positive electrode terminal 22 can be electrically connected with the battery positive electrode terminal 84, and therefore electrical connection between the wired circuit board 9 and the secondary battery 2 can be improved even more. Also, the charging-circuit negative electrode terminal 24 and the battery negative electrode terminal 83 can be electrically connected through the negative electrode tab 81 and the electrically conductive bonding material 120, and therefore electrical connection between the wired circuit board 9 and the secondary battery 2 can be improved even more. Furthermore, the up-down direction position of the external device negative electrode terminal contacting the tab 81 can be adjusted with the negative electrode tab 81. To be specific, the upper face of the negative electrode tab 81 can be flush with the upper face of the upper plate 72. Thus, the negative electrode terminal of the electronic device can be smoothly moved and led to the upper face of the negative electrode tab 81 while sliding the upper face of the upper plate 72, and the secondary battery 2 can be electrically connected with the negative electrode terminal of the electronic device through the negative electrode tab 81. Thus, the battery pack 1 can be easily attached to the electronic device.

The coil member 8 is a sheet coil including the first insulating base layer 10 and coiled wire 17.

Therefore, the thickness is smaller in up-down direction (thickness direction) compared with the case of the wound coil. Therefore, an even more small size can be achieved.

The circuit board 9 is a flexible wired circuit board including the control element 21.

Therefore, the circuit board 9 can be freely disposed in the housing 5 in conformity to the shapes of the housing 5 and secondary battery 2, and the space in the housing 5 can be efficiently used. Therefore, a smaller size can be achieved even more.

The battery pack 1 includes the magnetic sheet 4 between the coil member 8 and circuit board 9.

Therefore, when the coil member 8 receives electric power externally, the electric power can be converged to the coil member 8. Therefore, electric power receiving efficiency can be improved.

The main portion 70 of the housing 5 has the slit 74 positioned at the side of the secondary battery 2.

Therefore, the first joint base portion 33 can be accommodated in the slit 74. Thus, the internal diameter of the main portion 70 can be made smaller, and a smaller size can be achieved even more. Furthermore, the stress due to the expansion in radial direction at the time of charging and discharging of the secondary battery 2 can be released with the slit 74, and damages to the housing 5 can be suppressed.

The wireless power transmission system 100 includes the battery pack 1, and the power-supplying device 101 including the power-supplying coil 102.

Therefore, electric power can be transmitted wirelessly to the secondary battery 2 of the battery pack 1, and therefore the secondary battery 2 can be wirelessly charged.

<Hearing Aid>

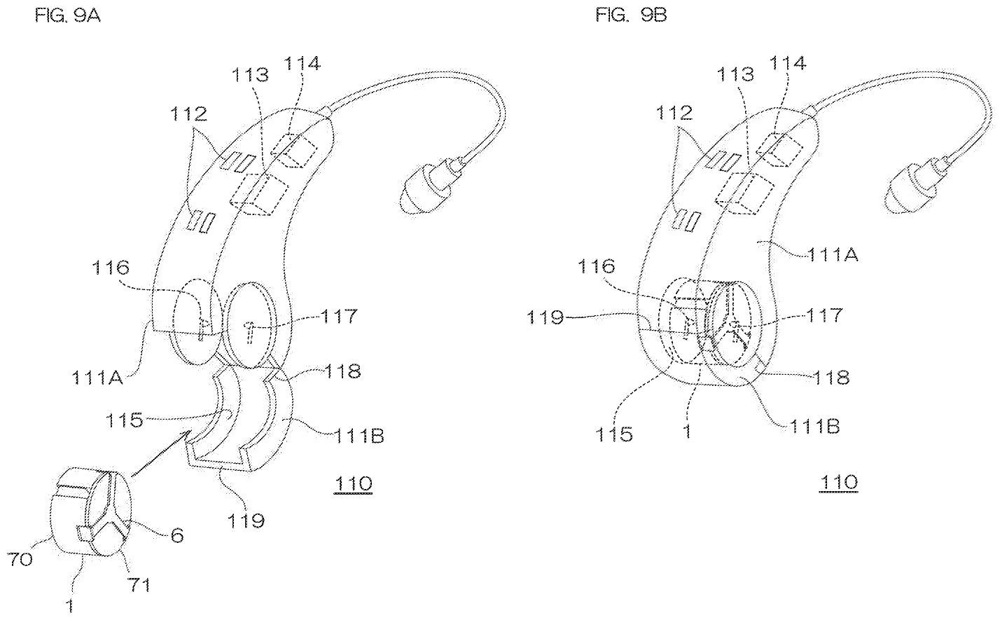

Next, with reference to FIGS. 9A-B, an embodiment of the hearing aid of the present invention is described.

The hearing aid 110 includes the battery pack 1, a hearing aid housing 111, microphone 112, amplifier 113, speaker 114, external device negative electrode terminal 116, and external device positive electrode terminal 117.

For the transformer 49 mounted on the battery pack 1 for the hearing aid 110, a transformer capable of converting to 1.2V is used.

The hearing aid housing 111 has a housing main portion 111A and an open-close mechanism 111B.

The housing main portion 111A accommodates a microphone 112, amplifier 113, speaker 114, external device negative electrode terminal 116, and external device positive electrode terminal 117 therein.

The external device negative electrode terminal 116 and external device positive electrode terminal 117 are disposed to face each other in spaced apart relation at the lower side of the housing main portion 111A. The space between the distal end (contact portion with battery pack 1) of the external device negative electrode terminal 116 and the distal end of the external device positive electrode terminal 117 is generally the same as the up-down direction length of the battery pack 1 (ref: FIG. 1A).

The microphone 112, amplifier 113, and speaker 114 are disposed inside the hearing aid housing 111, and they are electrically connected with the external device negative electrode terminal 116 and external device positive electrode terminal 117.

The open-close mechanism 111B is disposed at the lower end of the housing main portion 111A.

The open-close mechanism 11B is a curved plate member having an arc shape in side view and letter-U shape in front view, and one end (fixed end portion) 118 of the open-close mechanism 111B is fixed rotatably at the lower end of the housing main portion 111A through a hinge portion. The open-close mechanism 111B, and the space between the external device negative electrode terminal 116 and external device positive electrode terminal 117 form an accommodation unit 95.

The accommodation unit 115 has a space that can accommodate the battery pack 1. The accommodation unit 115 is configured to accommodate selectively the battery pack 1, or a commercially available primary battery (preferably, button type primary battery).

The accommodation unit 115 is accommodated inside the hearing aid housing 111, or exposed to the outside thereof by rotating the open-close mechanism 111B with the fixed end portion 118 as the supporting point. To be specific, as shown in FIG. 9A, the accommodation unit 115 is exposed to the outside (opened state) by moving a free end 119 (the other end opposite to the fixed end portion 118) of the open-close mechanism 111B to the lower side. Meanwhile, as shown in FIG. 9B, by moving the free end 99 to the upper side, the accommodation unit 115 is accommodated inside the hearing aid housing 111 (closed state).

When the open-close mechanism 11B is in opened state, the upper portion of the accommodation unit 115 is opened, and the battery pack 1 can be replaced. Meanwhile, when the open-close mechanism 11B is in closed state, the size and the shape inside the accommodation unit 115 is generally the same as those of the battery pack 1.

The battery pack 1 is accommodated in the accommodation unit 115. To be specific, as shown in FIG. 9B, the battery pack 1 is disposed inside the accommodation unit 115 so that, when the open-close mechanism 111B is in closed state, the external device negative electrode terminal 116 makes contact with the center portion 85 of the negative electrode tab 81, and the external device positive electrode terminal 117 makes contact with the center portion 90 of the metal member 6.

The hearing aid 110 includes the battery pack 1, hearing aid housing 111, microphone 112, amplifier 113, and speaker 114. Therefore, when the battery pack 1 is accommodated in the accommodation unit 115, the external device negative electrode terminal 116 can easily contact the center portion 85 of the negative electrode tab 81, and the external device positive electrode terminal 117 can easily contact the center portion 90 of the metal member 6. Furthermore, even if the external device positive electrode terminal 117 presses the center portion 90 of the metal member 6 inward of the battery pack 1, the metal member 6 is not easily deformed. Thus, the battery pack 1 can be easily attached to the hearing aid 110, and connection reliability with the battery pack 1 is excellent.

In the hearing aid 110, the accommodation unit 115 can also accommodate the primary battery. Therefore, it can be driven by any of the primary battery and secondary battery, and therefore it is convenient.

### MODIFIED EXAMPLE

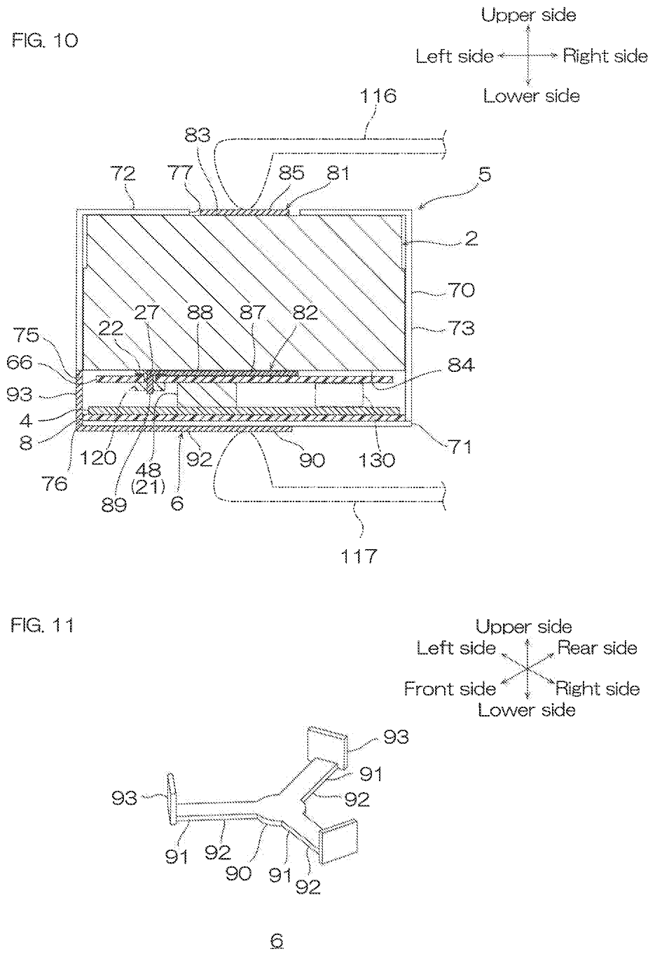

(1) In the embodiment shown in FIGS. 1A-B, the metal member 6 includes the hook 94, but for example, as shown in FIGS. 10 and 11, the metal member 6 does not have to include the hook 94.

In this embodiment, the metal member 6 (to be specific, upper end of the fitting portion 93) does not contact the lower face of the secondary battery 2, but contacts the main portion 70 of the housing 5 (to be specific, lower end of the fitted portion 75). That is, the metal member 6 directly supports only the main portion 70.

The same operations and effects can be achieved with the embodiment shown in FIGS. 1A-B. In view of suppressing wobbling of the secondary battery 2 and falling of the metal member 6, preferably, the embodiment shown in FIGS. 1A-B is used.

In this embodiment, in view of suppressing wobbling of the secondary battery 2, as shown in the phantom line of FIG. 10, the charging member 130 can be disposed between the control circuit base portion 30 and the magnetic sheet 4 so as to contact them.

(2) In the embodiment shown in FIGS. 1A-B, the metal member 6 includes three strip portions 91, but the number of the strip portion 91 is not limited, and for example, it can be two, or four or more.

In view of stability of the metal member 6, preferably, the number of the strip portion 91 is three or more.

(3) In the embodiment shown in FIGS. 1A-B and FIG. 6B, the center portion 90 of the metal member 6 overlaps with the center of the secondary battery 2 when projected in the thickness direction, but for example, although not shown, the center portion 90 can be disposed at a position that does not overlap with the center of the secondary battery 2 when projected in the thickness direction.

For example, the center portion 90 can be disposed at a peripheral end of the secondary battery 2.

In view of ease in contact with the positive electrode terminal of the electronic device, preferably, the embodiment shown in FIGS. 1A-B is used.

(4) In the embodiment shown in FIG. 1A-FIG. 2B, the secondary battery 2 includes the negative electrode tab 81 and positive electrode tab 82, but for example, although not shown, the secondary battery 2 does not have to include the negative electrode tab 81 and the positive electrode tab 82.

In this embodiment, the charging-circuit negative electrode terminal 24 directly contact the battery negative electrode terminal 83, and the battery-side circuit positive electrode terminal 22 directly contact the battery positive electrode terminal 84.

In view of electrical connection with the wired circuit board 9 and the secondary battery 2, and mountability of the battery pack 1, preferably, the embodiment shown in FIGS. 1A-B is used.

(5) In the embodiment shown in FIGS. 1A-B and FIGS. 3A-B, the battery pack 1 includes the coil-included board 3 in which the coil member 8 and circuit board 9 are integrally formed, but for example, although not shown, the coil member 8 and circuit board 9 can be formed from a separate component.

In this embodiment, the coil member 8 includes a plurality of (two) terminals for electrically connecting with the circuit board 9, and the circuit board 9 includes a plurality of (two) terminals for electrically connecting with the coil member 8. Then, these terminals are electrically connected and accommodated in the housing 5.

(6) In the embodiment shown in FIGS. 1A-B and FIGS. 3A-B, the circuit board 9 includes, as the control element 21, the rectifier 47, charge controller 48, and transformer 49, but for example, although not shown, the circuit board 9 can also include an element that comprehensively has two or three of the rectifier 47, charge controller 48, and transformer 49 as one component (for example, integrated circuit). Also, the circuit board 9 further can include, as the control element 21, another element such as a condenser for suppressing noises. The connection wire pattern 25 and base via portions 36 to 45 are suitably changed in accordance with the types and number of the control element 21. To be specific, for example, when one component (control element 21) that works as the rectifier 47, charge controller 48, and transformer 49 is used, the fifth connection wire 54, ninth connection wire 58, and tenth connection wire 59 are used as one connection wire, and through these connection wires, the charging-circuit negative electrode terminal 24 can be electrically connected with the control element 21.

(7) In the embodiment shown in FIGS. 1A-B and FIGS. 3A-B, the second joint base portion 34 includes a plurality of second bending portions 62, but for example, although not shown, the second joint base portion 34 can include only one second bending portion 62. In this case, at the time of assembly of the battery pack 1, the second bending portion 62 is bent to the lower side to 180 degrees to dispose the coil member 8 to the lower side of the control circuit base portion 30.

(8) In the embodiment shown in FIGS. 1A-B and FIG. 5, the battery pack 1 includes the magnetic sheet 4, but for example, although not shown, the battery pack 1 does not include the magnetic sheet 4.

In view of electric power receiving efficiency, preferably, the embodiment shown in FIGS. 1A-B is used.

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The battery pack and wireless power transmission system of the present invention can be applied to various industrial products, and can be suitably used for electronic devices in which secondary batteries and primary batteries are used. To be specific, for example, wearables such as hearing aid, smart glasses, smart watches; speakers; and medical devices.

### DESCRIPTION OF REFERENCE NUMERALS

1 battery pack
2 secondary battery
3 coil-included board
5 housing
6 metal member
8 coil member
9 circuit board
81 negative electrode tab
82 positive electrode tab
83 battery negative electrode terminal
84 battery positive electrode terminal
90 center portion
91 strip portion
93 fitting portion
94 hook
100 wireless power transmission system
101 power-supplying device
102 power-supplying coil
110 hearing aid
111 hearing aid housing
112 microphone
113 amplifier
114 speaker
115 accommodation unit

1. A battery pack comprising:
a secondary battery having a battery negative electrode terminal disposed at one side in the thickness direction and a battery positive electrode terminal disposed at the other side in the thickness direction,
a coil member,
a circuit board electrically connected with the battery negative electrode terminal, the battery positive electrode terminal, and the coil member,
a housing that accommodates the secondary battery, the coil member, and the circuit board, and
a metal member disposed at the other side in the thickness direction relative to the housing and is electrically connected with the circuit board,
wherein
the metal member has a plurality of strip portions extending along the direction orthogonal to the thickness direction of the housing from the inside of the housing toward the peripheral end edge, and connected to each other inside the housing,
the plurality of strip portions each has an end edge positioned at the peripheral end edge of the housing, and
each of the end edges of the plurality of strip portions is position defined at different positions at the peripheral end edge of the housing.

2. The battery pack according to claim 1, wherein
the metal member is electrically connected with the circuit board at the end edge of the strip portion.

3. The battery pack according to claim 1, wherein
the metal member has at least three strip portions.

4. The battery pack according to claim 1, wherein
the metal member includes a center portion overlapping with a center of the secondary battery when projected in the thickness direction, and
the strip portion extends radially from the center portion.

5. The battery pack according to claim 1, wherein
the end edge of the strip portion has a fitting portion, and
the peripheral end edge of the housing has a fitted portion to which the fitting portion fits.

6. The battery pack according to claim 5, wherein
the end edge of the strip portion has a hook extending inward from the distal end of the fitting portion.

7. The battery pack according to claim 1, wherein
the secondary battery includes a positive electrode tab and a negative electrode tab.

8. A wireless power transmission system comprising:
the battery pack according to claim 1, and
a power-supplying device including a power-supplying coil.

9. A hearing aid comprising:
the battery pack according to claim 1,
a hearing aid housing having an accommodation unit that accommodates the battery pack, and
a microphone, amplifier, and speaker provided inside the hearing aid housing.
